(19) United States
(12) Patent Application Publication
(10) Pub. No.: US 2025/0212120 A1
(43) Pub. Date: Jun. 26, 2025

(54) Methods And Apparatus For Generating On-Off Keying Signal In Mobile Communications

(71) Applicant: MediaTek Inc., Hsinchu City (TW)

(72) Inventors: Chien-Chun Cheng, Hsinchu City (TW); Chiao-Yao Chuang, Hsinchu City (TW); Chiou-Wei Tsai, Hsinchu City (TW); JunQiang Cheng, Beijing (CN); Tai-Cheng Tsai, Hsinchu City (TW); Wei-De Wu, Hsinchu City (TW); Tao Chen, Beijing (CN); You-Wei Chen, San Jose, CA (US)

(21) Appl. No.: 18/932,614

(22) Filed: Oct. 31, 2024

(30) Foreign Application Priority Data
Dec. 22, 2023 (WO) PCT/CN2023/141183
Dec. 25, 2023 (WO) PCT/CN2023/141413
Oct. 25, 2024 (CN) 202411502186.0

(51) Int. Cl. H04W 52/02; H04L 5/00; H04L 27/04

(52) U.S. Cl. CPC H04W 52/0229; H04L 5/0007; H04L 5/0048; H04L 27/04

(57) ABSTRACT

Various solutions for on-off keying (OOK) signal generation with respect to reader apparatus and an Internet of Things (IoT) device are described. A reader apparatus may generate an OOK signal with a discrete Fourier transform spread orthogonal frequency division multiplexing (DFT-s-OFDM) waveform or with a cyclic prefix-OFDM (CP-OFDM) waveform. The reader apparatus may transmit the OOK signal to an IoT device.

### CROSS REFERENCE TO RELATED PATENT APPLICATION(S)

The present disclosure is part of a non-provisional application claiming the priority benefit of PCT Application No. PCT/CN2023/141183, filed 22 Dec. 2023, PCT Application No. PCT/CN2023/141413, filed 25 Dec. 2023, and CN application Ser. No. 20/241,1502186.0, filed 25 Oct. 2024. The contents of aforementioned applications are herein incorporated by reference in their entirety.

### TECHNICAL FIELD

The present disclosure is generally related to mobile communications and, more particularly, to on-off keying (OOK) signal generation with respect to reader apparatus and internet of things (IoT) device in mobile communications.

### BACKGROUND

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G long term evolution (LTE) standard. There exists a need for further improvements in 5G NR technology. These improvements may also be applicable to other multi-access technologies and the telecommunication standards that employ these technologies.

Traditionally, an IoT device may use the on-off keying (OOK) for synchronization with the reader apparatus (e.g., UE readers or network node). However, the IoT device is not able to directly use/read the legacy 5G NR signals, e.g., a synchronization signal (SS).

Accordingly, how to provide the OOK signal for IoT transmission in the wireless communication environments such as 5G NR becomes an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to on-off keying (OOK) signal generation with respect to reader apparatus and internet of things (IoT) device in mobile communications. It is believed that the above-described issue would be avoided or otherwise alleviated by implementing one or more of the proposed schemes described herein.

In one aspect, a method may involve a reader apparatus generating an OOK signal with a discrete Fourier transform spread orthogonal frequency division multiplexing (DFT-s-OFDM) waveform or with a cyclic prefix-OFDM (CP-OFDM) waveform. The method may also involve the reader apparatus transmitting the OOK signal to an IoT device.

In another aspect, a method may involve an IoT device receiving an OOK signal from a reader apparatus, wherein the OOK signal is formed by a DFT-s-OFDM waveform or by a CP-OFDM waveform. The method may also involve the IoT device performing a backscattering transmission according to the OOK signal.

In another aspect, a reader apparatus may involve a transceiver which, during operation, wirelessly communicates with at least one network node. The apparatus may also involve a processor communicatively coupled to the transceiver such that, during operation, the processor may generate an OOK signal with a DFT-s-OFDM waveform or with a CP-OFDM waveform. The processor may also transmit, via the transceiver, the OOK signal to an IoT device.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for an A-IoT transmission architecture in accordance with implementations of the present disclosure.

FIG. 3 is a diagram depicting another example scenario for an A-IoT transmission architecture in accordance with implementations of the present disclosure.

FIG. 4 is a diagram depicting an example scenario for a reader apparatus or an IoT device in accordance with implementations of the present disclosure.

FIG. 5 is a diagram depicting another example scenario for a reader apparatus or an IoT device in accordance with implementations of the present disclosure.

FIG. 6 is a diagram depicting another example scenario for a reader apparatus or an IoT device in accordance with implementations of the present disclosure.

FIG. 7 is a diagram depicting an example scenario for a communication process in accordance with implementations of the present disclosure.

FIG. 8 is a diagram depicting an example scenario for a transmission architecture between a network node and an A-IoT device in accordance with implementations of the present disclosure.

FIG. 9 is a diagram depicting an example scenario for a transmission procedure in accordance with implementations of the present disclosure.

FIG. 10 is a diagram depicting an example scenario for a guard band configuration in accordance with implementations of the present disclosure.

FIG. 11 is a diagram depicting another example scenario for a guard band configuration in accordance with implementations of the present disclosure.

FIG. 12 is a diagram depicting an example scenario for a guard band configuration process in accordance with implementations of the present disclosure.

FIG. 13 is a diagram depicting an example scenario for a transmission architecture based on the DFT-s-OFDM in accordance with implementations of the present disclosure.

FIG. 14 is a diagram depicting an example scenario for a communication process based on the DFT-s-OFDM in accordance with implementations of the present disclosure.

FIG. 15 is a diagram depicting an example scenario for a transmission architecture based on the CP-OFDM in accordance with implementations of the present disclosure.

FIG. 16 is a diagram depicting an example scenario for a communication process based on the CP-OFDM in accordance with implementations of the present disclosure.

FIG. 17 is a diagram depicting an example scenario for a data handling process based on the DFT-s-OFDM in accordance with implementations of the present disclosure.

FIG. 18 is a diagram depicting an example scenario for a data handling process based on the CP-OFDM in accordance with implementations of the present disclosure.

FIG. 19 is a diagram depicting another example scenario for a data transmission process based on the DFT-s-OFDM or CP-OFDM in accordance with implementations of the present disclosure.

FIG. 20 is a block diagram of an example communication system in accordance with an implementation of the present disclosure.

FIG. 21 is a flowchart of an example process in accordance with an implementation of the present disclosure.

FIG. 22 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to on-off keying (OOK) signal generation with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

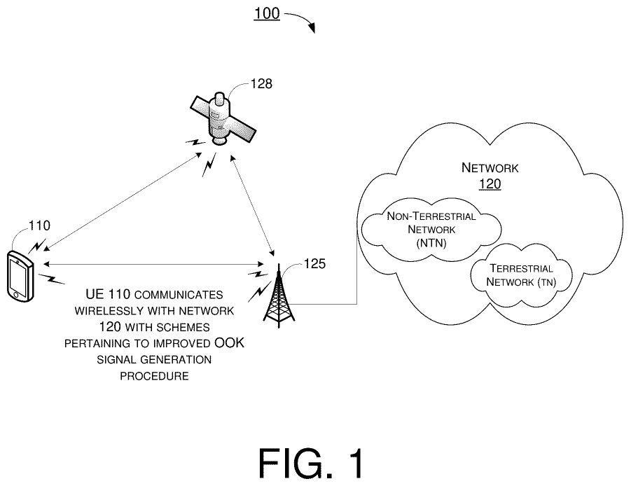

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to improved OOK signal generation procedure in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the implementations of the present disclosure, a reader apparatus (e.g., UE 110) may generate an OOK signal with a discrete Fourier transform spread orthogonal frequency division multiplexing (DFT-s-OFDM) waveform or with a cyclic prefix-OFDM (CP-OFDM) waveform. Then, the reader apparatus may transmit the OOK signal to an IoT device (e.g., an ambient IoT (A-IoT) device).

In an implementation, the reader apparatus may perform a DFT calculation and an inverse DFT (IDFT) calculation. In addition, the reader apparatus may add a CP to the OOK signal.

In an implementation, the reader apparatus may perform a transform precoding for the OOK signal.

In an implementation, the reader apparatus may receive a power adjustment indication from a network node (e.g., network node 125). The reader apparatus may transmit a power adjustment signal to the IoT device according to the power adjustment indication.

In an implementation, the reader apparatus may determine an equation according to a resource configuration for the OOK signal from a network node. Then, the reader apparatus may generate the DFT-s-OFDM waveform or the CP-OFDM waveform according to the equation.

In an implementation, the reader apparatus may determine an IoT-power information element (IE). Then, the reader apparatus may transmit the IoT-power IE to the IoT device.

In an implementation, the reader apparatus may determine whether to perform at least one of a cyclic redundancy check (CRC) and code block segmentation to generate the OOK signal.

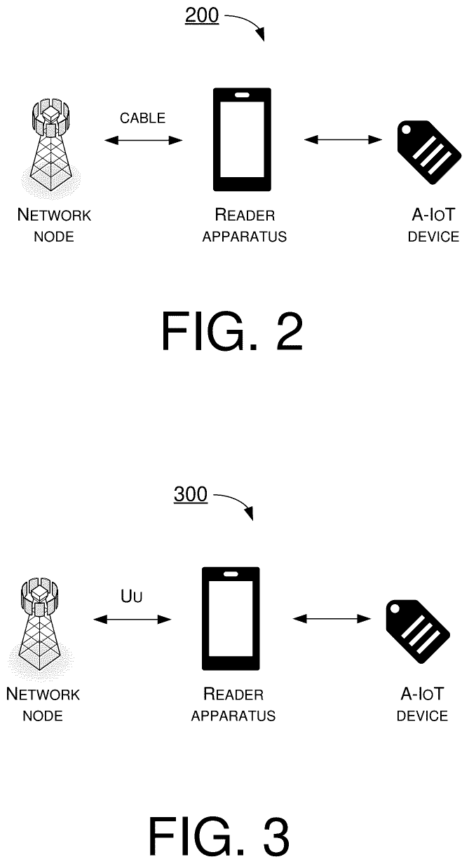

FIG. 2 illustrates an example scenario 200 for an A-IoT transmission architecture in accordance with implementations of the present disclosure. Scenario 200 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 2, the network node (e.g., a next-generation nodeB (gNB)) may establish a connection with the reader apparatus (e.g., a UE or a UE reader) via a wired cable. The configuration may eliminate the requirement for a new air interface between the network node and the A-IoT device. A new air interface between the reader apparatus and the A-IoT device may not be introduced. As shown in FIG. 2, the network node can access the A-IoT device via the reader apparatus. That is, the reader apparatus may be an intermediate node between the A-IoT device and the network node.

FIG. 3 illustrates another example scenario 300 for an A-IoT transmission architecture in accordance with implementations of the present disclosure. Scenario 300 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 3, the network node (e.g., a gNB) may establish a connection with the reader apparatus (e.g., a UE or a UE reader) via a wireless air interface. The air interface may be an NR-Uu interface to minimize the specification change on the reader apparatus. In addition, the air interface between the reader apparatus and the A-IoT device may be determined based on the use cases and requirements corresponding to the reader apparatus and the A-IoT device.

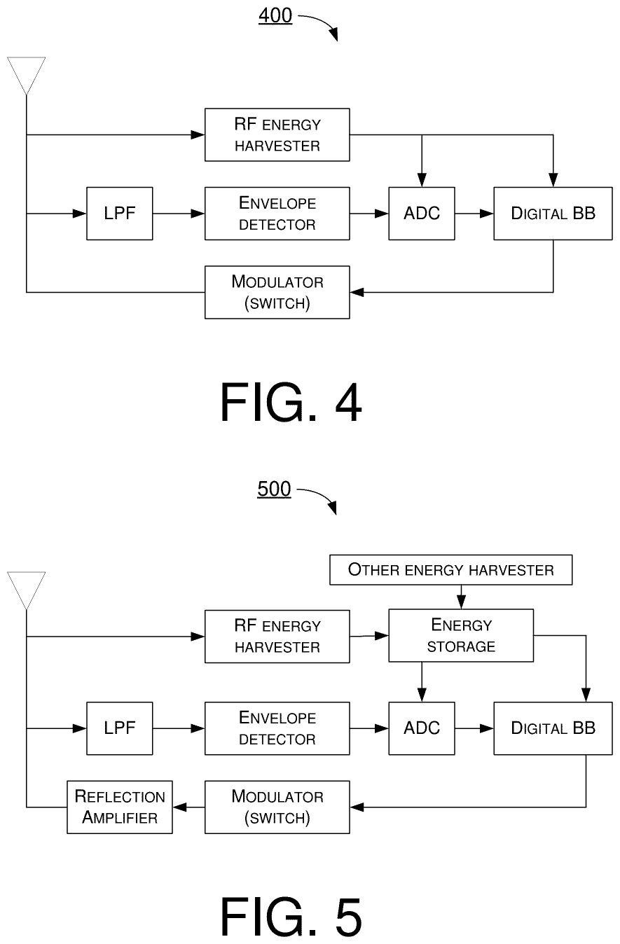

FIG. 4 illustrates an example scenario 400 for a reader apparatus or an IoT device in accordance with implementations of the present disclosure. Scenario 400 involves a reader apparatus. Referring to FIG. 4, the IoT device may be designed with specific targets. The IoT device may be designed for power consumption during transmission or reception (≤1 μW or ≤10 μW), and for complexity, which is aimed to be comparable to ultra-high-frequency radio-frequency-identification (UHF RFID) ISO18000-6C (EPC C1G2). In addition, as shown in FIG. 4, the IoT device may not have energy storage or independent signal generation and amplification capabilities. The IoT device may rely on backscattering transmission. The IoT device may require a backscattering activation power threshold, experience reflection loss, and need a distant carrier wave source to transmit signals for positioning. As shown in FIG. 4, the IoT device may comprise a low pass filter (LPF) for suppressing adjacent sub-carrier interference (ASCI) and adjacent carrier interference (ACI). The IoT device may also comprise an envelope detector (ED) to support OOK-based signals. The IoT device may also comprise an analog to digital converter (ADC) for digital baseband processing. The IoT device may also comprise a digital baseband (DBB) for sequence matching. The IoT device may also comprise a modulator (or a switch) controlled by the incoming signal to add payload data for OOK modulation. The IoT device may also comprise a radio frequency energy harvester to convert radio frequency (RF) signals into an energy source.

FIG. 5 illustrates another example scenario 500 for a reader apparatus or an IoT device in accordance with implementations of the present disclosure. Scenario 500 involves a reader apparatus. Referring to FIG. 5, the IoT device may be designed with specific targets. In addition, as show in FIG. 5, the IoT device may have energy storage but not have independent signal generation. The IoT device may rely on backscattering transmission. The stored energy may be used for signal amplification. The IoT device may also require a backscattering activation power threshold, experience reflection loss, and need a distant carrier wave source for positioning. As shown in FIG. 5, the IoT device may comprise an LPF for suppressing ASCI and ACI. The IoT device may also comprise an ED to support OOK-based signals. The IoT device may also comprise an ADC for digital baseband processing. The IoT device may also comprise a DBB for sequence matching. The IoT device may also comprise a modulator controlled by the incoming signal to add payload data for OOK modulation. The IoT device may also comprise an RF energy harvester to convert RF signals into an energy source. The IoT device may also comprise additional energy harvesters for different types of ambient power sources, such as RF radio, solar energy, thermal energy, and piezoelectric power. The IoT device may also comprise an energy storage, such as capacitors and solid-state batteries. The IoT device may also comprise a reflection amplifier to amplify the input signal to the tag and the backscattered signal towards the reader apparatus.

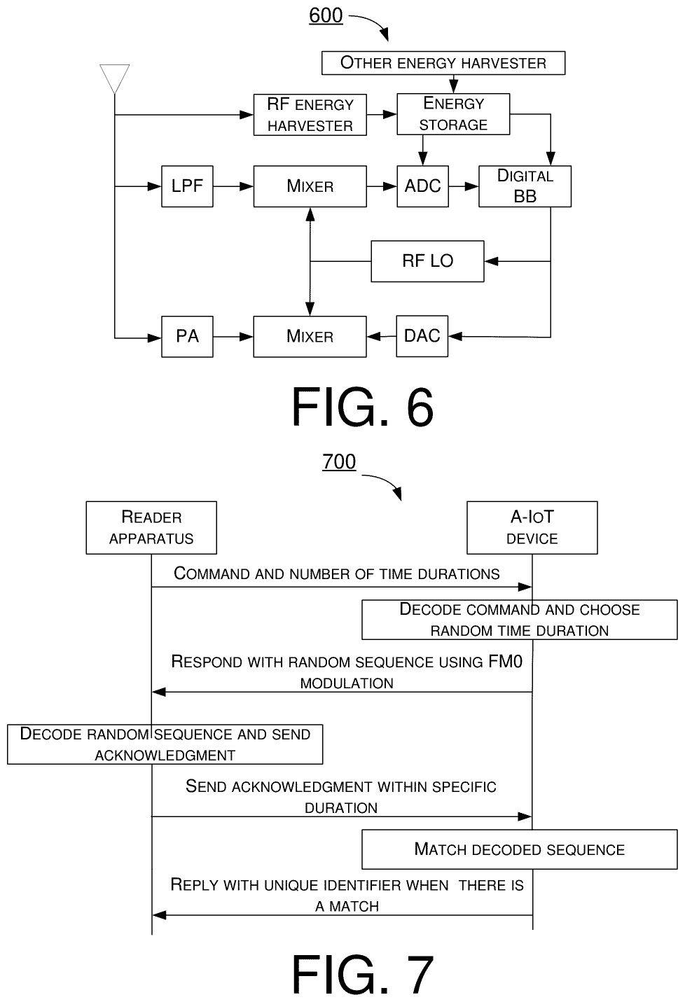

FIG. 6 illustrates another example scenario 600 for a reader apparatus or an IoT device in accordance with implementations of the present disclosure. Scenario 600 involves a reader apparatus. Referring to FIG. 6, the IoT device may be designed with specific targets. For example, the IoT device may be designed for a power consumption during transmission or reception (≤1 mW to ≤10 mW), and for a complexity that is orders-of-magnitude lower than Narrow Band IoT (NB-IoT). In addition, as shown in FIG. 6, the IoT device may have energy storage, independent signal generation, and active RF components for transmission. The IoT device may also have mobility management capabilities, at least for cell selection and re-selection. As shown in FIG. 6, the IoT device may comprise an LPF for suppressing ASCI and ACI. The IoT device may also comprise an ED to support OOK-based signals. The IoT device may also comprise an ADC for digital baseband processing. The IoT device may also comprise a DBB for synchronization, payload decoding, and cyclic redundancy check (CRC). The IoT device may also comprise an RF energy harvester to convert RF signals into an energy source. The IoT device may also comprise additional energy harvesters for different types of ambient power sources, such as RF radio, solar energy, thermal energy, and piezoelectric power. The IoT device may also comprise an energy storage, such as capacitors and solid-state batteries. The IoT device may also comprise a low-noise amplifier (LNA) and power amplifier (PA) to amplify reception and transmission signals.

FIG. 7 illustrates an example scenario 700 for a communication process in accordance with implementations of the present disclosure. Scenario 700 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 7, there may be an innovative air interface for communication between the reader apparatus (e.g., a UE reader or a network node (e.g., a gNB)) and the A-IoT device. As shown in FIG. 7, the communication process may be initiated when the reader apparatus powers up the A-IoT device and transmits a command. The command may comprise the essential communication parameters, e.g., the tag rate, the tag data encoding method, and the total number of available time durations. When the A-IoT device has harvested enough energy, the A-IoT device may be activated and listen for the command from the reader apparatus. After the A-IoT device decode the command, the A-IoT device may randomly select a time duration from the available range, and generate a random sequence. Then, the A-IoT device may transmit the random sequence to the reader apparatus in the chosen time duration. The random sequence may be modulated by frequency modulation 0 (FMO), and the random sequence may be preceded by a known preamble sequence. In response to the random sequence from the A-IoT device, the reader apparatus may decode the random sequence and send an acknowledgment back to the A-IoT device within a predetermined duration aligning with the configuration for the A-IoT rate. The reader apparatus discussed above may be a node, e.g., a UE, a UE reader a relay, IAB node, NR/LTE UE, repeater, or a base station (gNB).

According to an implementation of the present disclosure, the UE-to-A-IoT device communication link (U2A Link) may use modulation scheme like amplitude shift keying (ASK) or OOK to facilitate pulse interval encoding (PIE) for data transmission. The U2A link may include two preambles. One preamble is a long U2A preamble for initial transmission and the other preamble is a short U2A preamble for subsequent signaling. The UE may transmit the long U2A preamble and a control signal (or command) which is specifies the control parameters for the A-IoT device to the A-IoT device.

According to an implementation of the present disclosure, the A-IoT device-to-UE communication link (A2U Link) may use either ASK or phase shift keying (PSK) modulation. The A-IoT may encode backscattered data using either FMO baseband or Miller modulation which is controlled by the UE or gNB via the A2U link. The A2U link signaling may be initiated with one of two Miller subcarrier preambles base on the command or the control signal. The A-IoT device may use backscatter modulation based on its antenna's reflection coefficient to transmit data. The A2U link may be used to transmit electronic product code (EPC) and protocol-control (PC) information.

According to implementations of the present disclosure, the existing network node (e.g., gNB) hardware may be used to generate OOK signals for A-IoT devices which use the backscattering transmission.

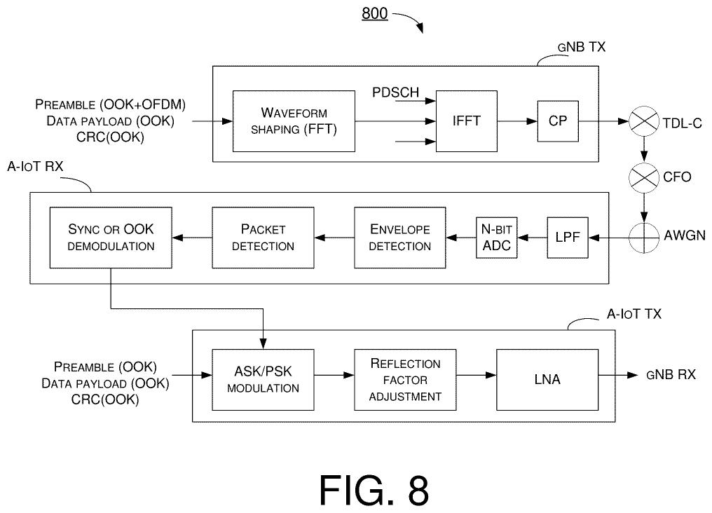

FIG. 8 illustrates an example scenario 800 for a transmission architecture between a network node and an A-IoT device in accordance with implementations of the present disclosure. Scenario 800 involves an A-IoT device and a network node (e.g., a (macro/micro) base station) which may be a part of a wireless network (e.g., an LTE network, a 5G/NR network, an IoT network or a 6G network). The network node also can be regarded as a reader apparatus, i.e., the scenario 800 also can be applied to another reader apparatus, e.g., a UE reader. Referring to FIG. 8, a transmission end of the network node (e.g., gNB TX) may perform a signal generation, a waveform shaping, an inverse fast Fourier transform (IFFT) multiplexing operation, and a cyclic prefix (CP) addition. A receiving end of the A-IoT device (e.g., A-IoT RX) may perform a low pass filter (LPF) function, an analog-to-digital convertor (ADC) operation, an energy detection, a packet detection, and a synchronization (or an OOK demodulation). A transmission end of the A-IoT device (e.g., A-IoT TX) may perform an ASK or PSK modulation, a reflection factor adjustment, and a LNA operation.

The transmitted OOK signal may comprise at least one of a preamble, a data payload, and a CRC. The preamble may be generated by an OFDM sequence. The OFDM sequence may be known by the A-IoT devices, UE reader, or gNB. The preamble may be used by the A-IoT devices for a synchronization, a packet detection, and a backscattering transmission. For example, the OFDM sequences may be used to overlay over the OOK symbols. The CRC type may be CRC-4, CRC-8, CRC-16, or CRC-32. In addition, the CRC type may be based on the error detection requirement of the A-IoT device.

The waveform shaping may be performed to generate the OOK waveform. The OOK waveform may have on and off periods in the time domain. A waveform shaping module may be needed to perform the waveform shaping. The waveform shaping module may be a least-squared solution of a linear matrix multiplexing to minimize the squared errors between the IFFT output and the target OOK waveform.

The IFFT module may multiplex the A-IoT signal with 5 MHz bandwidth and the physical downlink shared channel (PDSCH) signal with the rest of the bandwidth (15 MHz for example). The multiplexing operation may require guard resource blocks (RB) between A-IoT signal and NR PDSCH signal to prevent interference.

The CP adding operation may be performed to prevent interference from A-IoT signal to NR PDSCH signal. However, for A-IoT devices with OOK receivers, the CP may be redundant and as a result it may cause inter-symbol interference for OOK demodulation. In order to assist the A-IoT devices in removing the CP, the reader apparatus (e.g., gNB or UE reader) may broadcast assistance information (e.g., a subcarrier spacing (SCS), CP types, and a symbol index) in system information blocks (SIBs) or a query command.

An LPF may be needed to suppress adjacent subcarrier interference (ASCI) and adjacent channel interference (ACI). The LPF requirement may be based on the A-IoT signal locations. Different signal locations may require different guard band resource blocks (RB) to prevent interference. The reader apparatus (e.g. gNB or UE reader) may transmit the configurations about the signal location and the number of guard band RBs via NR signal or channel to the A-IoT device.

The ADC may use few bits and a low sampling rate to save power consumption. If the reader apparatus (e.g., gNB or UE reader) requests the ADC information, the A-IoT device may report its ADC range, bits, or sampling rates. The ADC range may be related to the interference level, with higher interference requiring a wider ADC range.

The energy detector (ED) may be used to perform energy detection by extracting the absolute amplitude based on the correct direct current (DC) level. In order to obtain the correct DC level, the reader apparatus (e.g., gNB or UE reader) may send the preambles before data parsing. The preamble may be used by A-IoT devices for auto gain control (AGC), timing and frequency synchronization, and DC level estimation.

The packet detection module may monitor the specific time, frequency, and sequences for energy harvesting and A-IoT signal detection. The monitoring operation may be continuous if the traffic is on-demand and no periodic reporting is required. The known time, frequency resources, and sequences may be provided by the network from the reader apparatus (e.g., gNB or UE reader) when the connection between the A-IoT device and the reader apparatus is established.

In an example, after the packet detection and the coarse synchronization have been completed, the A-IoT device may use the preamble or the CRC to perform fine synchronization. In another example, the A-IoT device may perform OOK demodulation if the channel coding and modulation types are provided by the reader apparatus (e.g., gNB or UE reader) via the NR channel or signal.

If a packet is detected and the OOK signal is parsed successfully, the A-IoT device TX may backscatter the detected and parsed OOK signal though the ASK or PSK modulation based on at least one of the UL preamble, data, and CRC of the OOK signal. The A-IoT devices may backscatter or reflect the OFDM signal underlaid in the OOK signal, if the reader apparatus (e.g., gNB or UE reader) provides the indications or the configurations via the NR channel or signal.

The reflection factor is used to control the reflection level of the output waveform. The reflection factor may modulate the output signal for the input information such as the preamble, data payload, and CRC of the OOK signal. The A-IoT devices may only choose to reflect or not reflect on the received OOK signal, so the output signal may be ASK or frequency shift keying (FSK). The modulation types may be configurable by the reader apparatus (e.g., gNB or UE reader) via the NR channel or signal based on the capability reporting via the NR channel.

The LNA may be a reflecting amplifier which is used for UL power control. The amplifier power may be configured by the reader apparatus (e.g., gNB or UE reader) via the NR channel or signal. The A-IoT device may control its UL power by adjusting the LNA based on the received signal power.

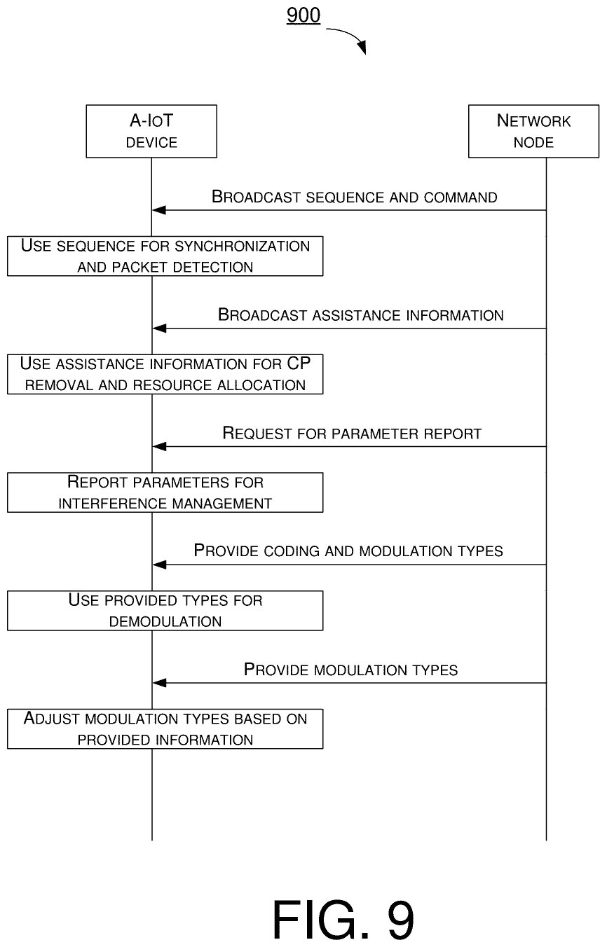

FIG. 9 illustrates an example scenario 900 for a transmission procedure between a network node and an A-IoT device in accordance with implementations of the present disclosure. Scenario 900 involves an A-IoT device and a network node (e.g., a (macro/micro) base station) which may be a part of a wireless network (e.g., an LTE network, a 5G/NR network, an IoT network or a 6G network). The network node also can be regarded as a reader apparatus, i.e., the scenario 900 also can be applied to another reader apparatus, e.g., a UE reader. Referring to FIG. 9, the transmission procedure may comprise the steps of broadcasting a sequence and a command, broadcasting assistance information, requesting for a parameter report, providing coding and modulation types, and providing modulation types. The corresponding actions of the A-IoT device in response to each network action are also depicted.

In the transmission procedure, the network node may initiate all actions. The network node may broadcast the sequence and command. The A-IoT device may use the sequence and command for synchronization and packet detection. Then, the network may broadcast the assistance information. The A-IoT device may use the assistance information for the CP removal and resource allocation. To manage interference levels, the network may also request a parameter report from the A-IoT device. Then, the A-IoT device may report its parameters to the network node for interference management. For the demodulation, the network may provide the coding and modulation types to the A-IoT device. The A-IoT device may use the provided coding and modulation types for demodulation. Finally, the network node may provide the modulation types to the A-IoT device, and then, the A-IoT device may adjust its modulation types based on this provided information.

As shown in FIG. 9, several key behaviors may be performed by the A-IoT device for the corresponding network signaling requirements.

For synchronization and packet detection, the A-IoT device may utilize a received sequence for synchronization and packet detection. A detection period may be initiated from a defined frame and may be governed by the smallest value in the set determined by the sequence period. During the detection period, all sequence block indexes may be mapped to the packet detection occasions at least once. The network node may broadcast a sequence and a command indicating the commencement of a packet. The sequence period may be derived from the relevant system information.

For the operations of the removal of the CP and the resource allocation, the A-IoT device may use the received assistance information. The allocation period which initiates from a defined frame may be determined by the smallest value in the set according to the CP configuration period. Within the allocation period, all CP block indexes may be mapped to the resource allocation occasions at least once. The network node may broadcast assistance information which comprises relevant parameters in system information blocks (SIBs) or a query command. The CP configuration period may be derived from the relevant system information.

The A-IoT device may also play a role in managing the interference level by reporting its parameters to the network node. The report period which initiates from a defined frame may be determined by the smallest value in the set according to the configuration period. Within the report period, all block indexes may be mapped to the interference management occasions at least once. The network may request the A-IoT device to report its parameters. The configuration period may be derived from the relevant system information.

For the demodulation, the A-IoT device may use the provided coding and modulation types. The demodulation period which initiates from a defined frame may be determined by the smallest value in the set according to the configuration period. Within the demodulation period, all block indexes may be mapped to the demodulation occasions at least once. The network may provide the specific coding and modulation types for demodulation. The configuration period may be derived from the relevant system information.

The A-IoT device may adjust its modulation types based on the information provided by the network. The adjustment period which initiates from a defined frame may be determined by the smallest value in the set according to the modulation configuration period. Within the adjustment period, all modulation block indexes may be mapped to the adjustment occasions at least once. The network may provide the specific modulation types based on the capability report of the A-IoT device. The modulation configuration period may be derived from the relevant system information.

As shown in FIG. 9, several key behaviors may be performed by the reader apparatus (e.g., gNB or UE reader) for the corresponding signaling requirements from the A-IoT device.

The reader apparatus (e.g., gNB or UE reader) may broadcast the sequence and command. The broadcast period may start from a defined frame and may be determined by the sequence period to ensue all sequence block indexes are broadcasted at least once within the broadcast period. The A-IoT device may need to receive the broadcast in the readiness state reported in the relevant system information.

The reader apparatus (e.g., gNB or UE reader) may broadcast assistance information for certain operations and resources. The broadcast period may start from a defined frame and may be determined by the assistance configuration period to ensure all assistance block indexes are broadcasted at least once within the broadcast period. The A-IoT device may request the assistance information in the request period obtained from the relevant system information.

The reader apparatus (e.g., gNB or UE reader) may use the reported parameters from the A-IoT device to manage the interference level. The management period may start from a defined frame and may be determined by the interference management configuration period to ensure all management block indexes are used at least once within the management period. The A-IoT device may reports its parameters in the reporting period obtained from the relevant system information.

The reader apparatus (e.g., gNB or UE reader) may provide the coding and modulation types to the A-IoT device. The provision period may start from a defined frame and may be determined by the provision configuration period to ensure all provision block indexes are provided at least once within the provision period. The A-IoT device may request the coding and modulation types in the request period obtained from the relevant system information.

The reader apparatus (e.g., gNB or UE reader) may provide modulation types based on the reported capabilities of the A-IoT device. The provision period may start from a defined frame and may be determined by the provision configuration period to ensure all provision block indexes are provided at least once within the provision period. The A-IoT device may report its capabilities in the reporting period obtained from the relevant system information.

The configuration and signaling of adjacent subcarrier and adjacent carrier guard resource blocks may be needed for A-IoT signals to ensure effective interference prevention and optimal performance in the communication networks.

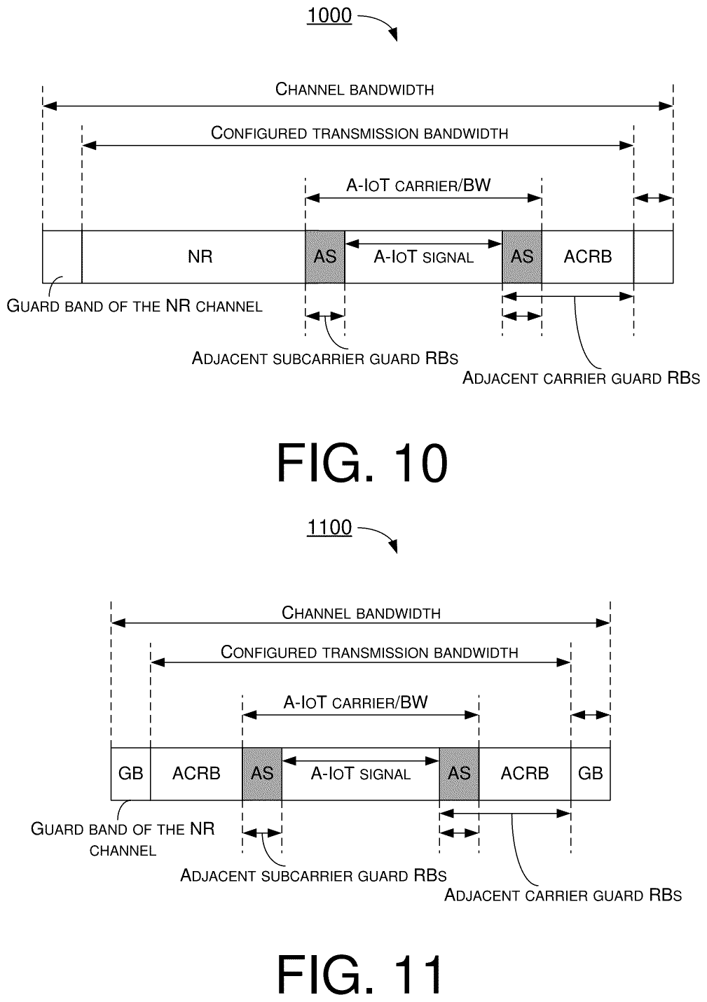

FIG. 10 illustrates an example scenario 1000 for a guard band configuration in accordance with implementations of the present disclosure. Scenario 1000 involves an A-IoT device and a reader apparatus (e.g., a network node or a UE). Referring to FIG. 10, for the deployment position of the A-IoT signal, different numbers of guard resource blocks (e.g., blanked resource blocks) may be required. The guard resource blocks may be configured by the network node, and signaled from the network node to the UE reader or A-IoT device via NR signals and channels.

As shown in FIG. 10, the adjacent subcarrier guard resource blocks (ASRBs) may be added on both sides of the A-IoT signal bandwidth. The range of the ASRBs may be from 0.5 RB to 2 RBs for 30 kilohertz (KHz) subcarrier spacing (SCS), or from 1 RB to 4 RBs for 15 KHz SCS. The ASRBs may be used to protect the A-IoT signal from interference from nearby the sub-carrier NR signals (e.g., PDSCH) or intra-cell interference. In addition, as shown in FIG. 10, the adjacent carrier guard resource blocks (ACRBs) may be added on one side of the A-IoT signal bandwidth when the channel bandwidth is more than 10 MHz, or the A-IoT signal bandwidth is less than 5 MHz. The range of the ACRBs may be from 1 RB to 3 RBs for 30 KHz SCS, or from 2 RBs to 6 RBs for 15 KHz SCS. The ACRBs may be used to protect the A-IoT signal from interference from the nearby carrier NR signals, e.g., the inter-cell interference.

FIG. 11 illustrates another example scenario 1100 for a guard band configuration in accordance with implementations of the present disclosure. Scenario 1100 involves an A-IoT device and a reader apparatus (e.g., a network node or a UE). Referring to FIG. 11, the ACRBs may be added on both sides of the A-IoT signal bandwidth in a 5G network when the channel bandwidth is less than 10 MHz or the A-IoT signal bandwidth is more than 5 MHz.

The range of ACRBs may be from 1 RB to 3 RBs for 30 KHz SCS, or 2 RBs to 6 RBs for 15 KHz SCS. The ACRBs may be used to protect the A-IoT signal from interference from nearby carrier NR signals, e.g., the inter-cell interference. The number of ACRBs may be configured by the network node and signaled from the network node to the UE reader or A-IoT via NR signals and channels.

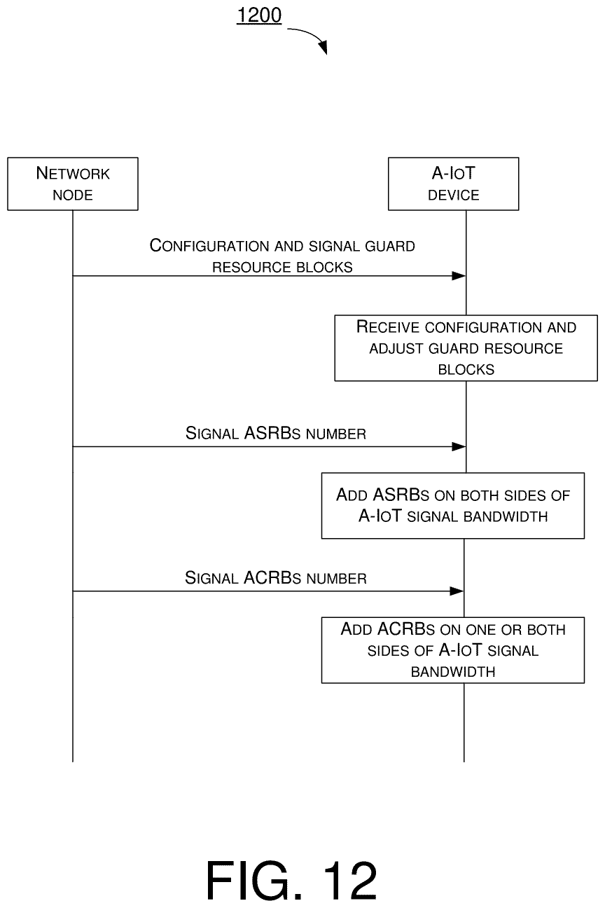

FIG. 12 illustrates an example scenario 1200 for a guard band configuration process in accordance with implementations of the present disclosure. Scenario 1200 involves an A-IoT device and a network node (e.g., a (macro/micro) base station) which may be a part of a wireless network (e.g., an LTE network, a 5G/NR network, an IoT network or a 6G network). The network node also can be regarded as a reader apparatus, i.e., the scenario 1200 also can be applied to another reader apparatus, e.g., a UE reader. Referring to FIG. 12, the network node may initiate the process by configuring and signaling the guard resource blocks to the A-IoT device. Upon receiving the configuration, the A-IoT device may adjust its guard resource blocks accordingly. Then, the network node may transmit or signal the number of ASRBs and ACRBs to the A-IoT device. The A-IoT device may add the guard resource blocks (i.e., the ASRBs and ACRBs) on the both sides or one side of its signal bandwidth based on the guard band configuration from the network node.

As shown in FIG. 12, several key behaviors may be performed by the A-IoT device for the corresponding network signaling requirements.

The A-IoT signals may be deployed at various positions within the channel bandwidth. According to the position, different numbers of guard resource blocks may be required. These guard blocks may be blanked resource blocks. The guard resource blocks may be used for mitigating the interference and ensuring the signal integrity. The network node may configure and signal the guard resource blocks to the A-IoT device via NR signals and channels to allow the A-IoT device to adapt to different deployment positions.

The ASRBs may be added on both sides of the A-IoT signal bandwidth. The ASRBs may be used to protect the A-IoT signal from interference from the nearby sub-carrier NR signals (such as PDSCH) or the intra-cell interference. The range of the ASRBs may be from 0.5 RB to 2 RBs for 30 KHz SCS, or from 1 RB to 4 RBs for 15 KHz SCS. The network node may configure and signal the number of ASRBs to the A-IoT device to allow the A-IoT device to dynamically adjust according to the changes in the interference environment.

The ACRBs may be added to one or both sides of the A-IoT signal bandwidth according to the channel bandwidth and the A-IoT signal bandwidth. The ACRBs may be used to protect the A-IoT signal from interference from the nearby carrier NR signals, e.g., the inter-cell interference. The range of the ACRBs may be from 1 RB to 3 RBs for 30 KHz SCS, or from 2 RBs to 6 RBs for 15 KHz SCS. The network node may configure and signal the number of ACRBs to the A-IoT device to enabling the A-IoT device to effectively manage inter-cell interference.

The behaviors and signaling requirements may make the A-IoT devices can effectively manage interference and maintain optimal performance within the 5G network.

According to implementations of the present disclosure, the existing UE hardware may be used to generate the OOK signals with the DFT-s-OFDM waveform or with the CP-OFDM waveform for A-IoT devices which use the backscattering transmission.

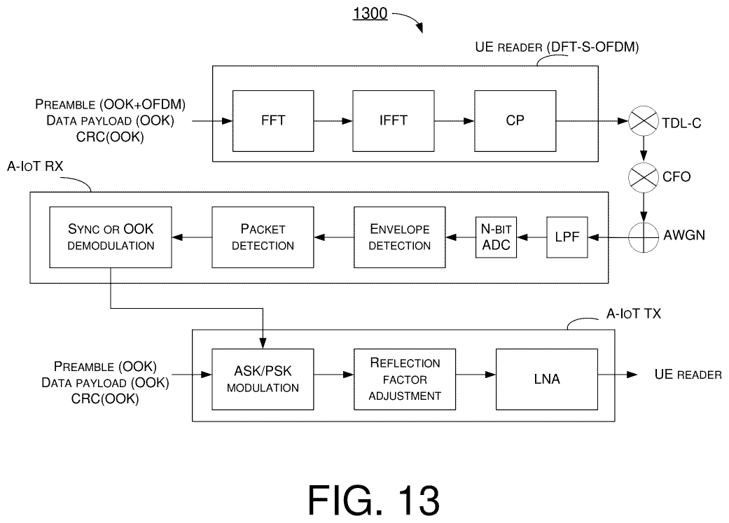

FIG. 13 illustrates an example scenario 1300 for a transmission architecture based on the DFT-s-OFDM in accordance with implementations of the present disclosure. Scenario 1300 involves an A-IoT device and a UE (or a UE reader). The UE can be regarded as a reader apparatus. Referring to FIG. 13, if the UE reader supports the DFT-s-OFDM uplink (UL) transmission, the UE reader may spread the A-IoT symbols over the entire signal bandwidth without using other UL NR signal multiplexed in the same OFDM symbols. That is, the UE reader may use its UL transmission to communicate with the A-IoT device.

The DFT-s-OFDM modulation may have a lower peak-to-average power ratio (PAPR) than the CP-OFDM modulation. Therefore, the UE reader adopting the DFT-s-OFDM modulation for data transmission may have a higher/better average power to improve uplink coverage performance. For the OOK signals transmitted from the UE reader to an A-IoT device, the DFT-s-OFDM modulation may be selected for better coverage. For the subsequent physical uplink shared channel (PUSCH) transmission or A-IoT signal transmission, the network node may dynamically reconfigure the UE reader according to coverage conditions.

The OOK signal (or A-IoT waveform) may be generated through the transform precoding operation and/or the CP-OFDM operation. The transform precoding may be the least square (LS) precoding or the FFT (or DFT) precoding. The robustness for reducing the frequency selective fading may be enhanced by using a flat spectrum in the frequency domain. The flat spectrum may be achieved in OOK modulation by using an OFDM sequence to overlay over the OOK symbols before the DFT precoding or the LS precoding is performed with variable phase.

In order to reduce the complexity of waveform generation at the network node or UE reader, the generated frequency domain samples mapped to the A-IoT sub-carrier segment of IFFT may be pre-stored. The memory requirement for the pre-store information may depend on the number of bandwidth sizes supported by the A-IoT device.

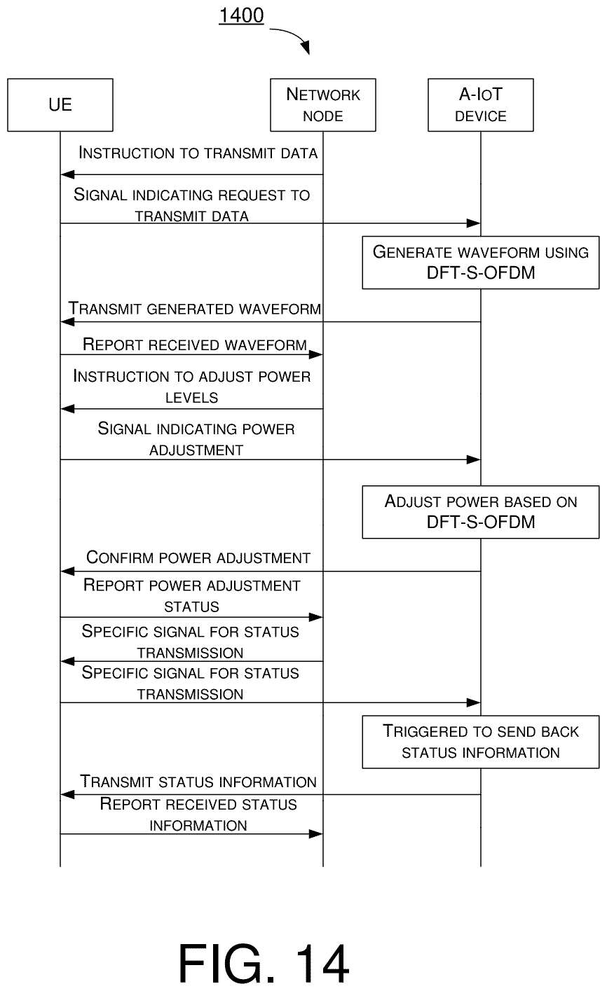

FIG. 14 illustrates an example scenario 1400 for a communication process based on the DFT-s-OFDM in accordance with implementations of the present disclosure. Scenario 1400 involves a UE (or UE reader), an A-IoT device and a network node (e.g., a (macro/micro) base station) which may be a part of a wireless network (e.g., an LTE network, a 5G/NR network, an IoT network or a 6G network). Referring to FIG. 14, the network node (e.g., a gNB) may transmit the instructions to the UE reader. Then, the UE reader may transmit the instructions to the A-IoT device via OOK signals. The A-IoT device may generate a DFT-s-OFDM waveform and/or adjust its power levels according to the indications from the UE reader. The UE reader may report the actions or operations associated with the A-IoT device to the network node. In addition, the network node may also transmit a specific signal to the A-IoT device via the UE reader to trigger the A-IoT device to transmit its status information to the UE reader. Then, the UE reader may transmit the status information of the A-IoT device to the network node.

The behavior of the A-IoT device and data processing operations may be performed according to the configurations or the signaling received from the UE reader or the network node. The configurations or instructions may be used to indicate the A-IoT device how to process the data with different sizes, generate the waveforms, adjust the power levels, and transmit status information.

The UE reader may configure the configurations or the signaling to the A-IoT device via the RRC messages in the physical downlink shared channel (PDSCH). For example, if the DFT-S-OFDM waveform is used in the PUSCH or other DL NR channel (e.g., the physical random access channel (PRACH) or physical uplink control channel (PUCCH)), the UE reader can use the n/2 BPSK or the A-IoT waveform (e.g., ASK or FSK).

The equation used to generate the A-IoT waveform may be reused for the PRACH, or for all physical channels and signals except the PRACH. The equation may comprise several parameters which may be configured by the network node through the system information (SI) messages or the RRC messages in the PDSCH.

The A-IoT-power information element (IE) configured by the network node through a RRC message for the CP-OFDM case (i.e., the transform precoding is disabled) may be used to boost the transmission power of the A-IoT devices, e.g., the transmission power of the PUSCH or PRACH. The size of the boost may be determined according to the number of layers used by the PUSCH. The size of the boost may be become larger for an increased number of layers.

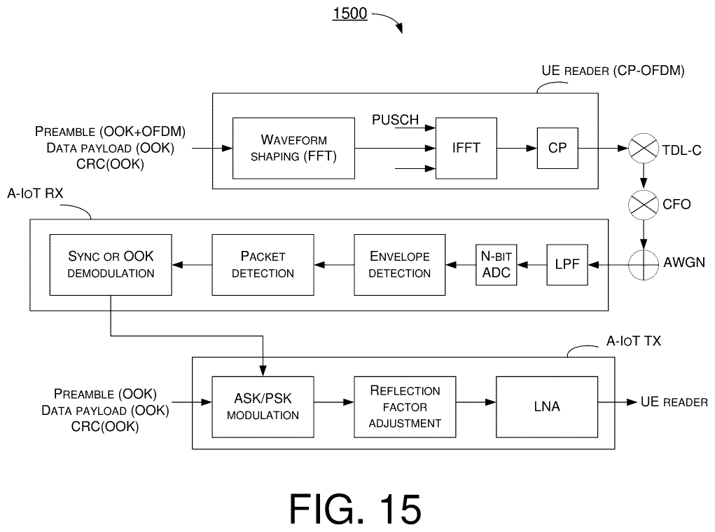

FIG. 15 illustrates an example scenario 1500 for a transmission architecture based on the CP-OFDM in accordance with implementations of the present disclosure. Scenario 1500 involves an A-IoT device and a UE (or a UE reader). The UE can be regarded as a reader apparatus. Referring to FIG. 15, the transmission architecture of FIG. 15 may be similar to the transmission architecture between the network node and the A-IoT device (e.g., the transmission architecture of FIG. 8) if the UE reader supports CP-OFDM UL. The distinguishing between the two transmission architectures is that the UE reader may use its UL transmission to communicate with the A-IoT device. Therefore, the IFFT module can be used for the PUSCH multiplexing with the A-IoT signal if the UE reader is compatible with the CP-OFDM UL.

The DC subcarrier may be excluded to prevent the potential interference from local oscillator leakage.

The A-IoT waveform may be generated by reusing the equation used for the PRACH, or for all other physical channels and signals except the PRACH. The equation may comprise several parameters, e.g., the total number of subcarriers, the common resource blocks, the point A, the resource element index, the length of the PRACH sequence, the PRACH subcarrier spacing, the subcarrier spacing of the relevant uplink bandwidth part (BWP), and the subcarrier spacing of the first resource block assigned to the PRACH. The network node may adjust the parameters through the SI messages or the RRC messages transmitted in the PDSCH.

The A-IoT-Power IE may be configured by the network node via an RRC message for the CP-OFDM case (i.e., when the transform precoding is not enabled). The A-IoT-Power IE may be used to enhance the transmission power of the A-IoT devices compared to the transmission power of the PUSCH or PRACH. The range of the power boost may be dependent on the number of layers used by the PUSCH.

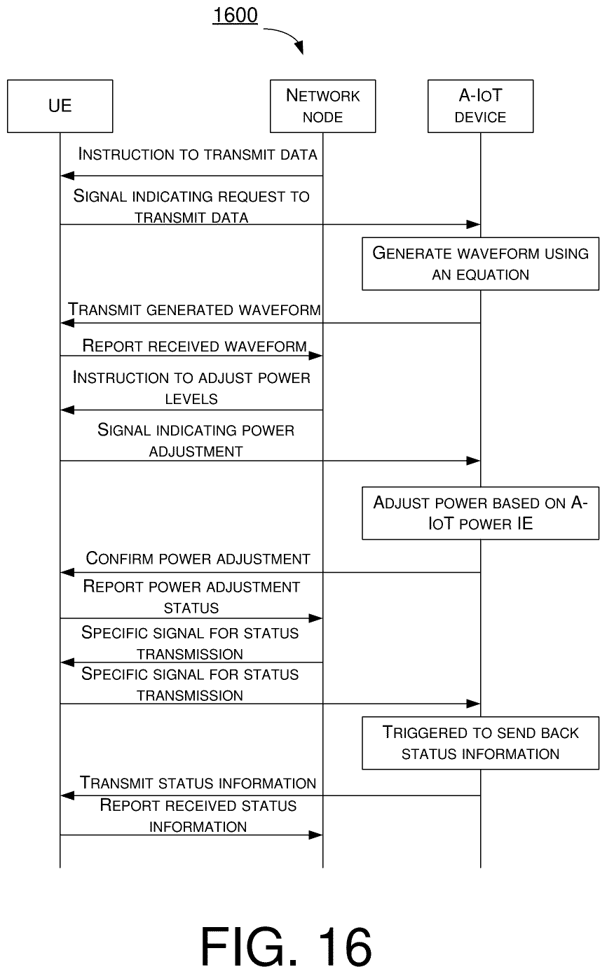

FIG. 16 illustrates an example scenario 1600 for a communication process based on the CP-OFDM in accordance with implementations of the present disclosure. Scenario 1600 involves a UE (or UE reader), an A-IoT device and a network node (e.g., a (macro/micro) base station) which may be a part of a wireless network (e.g., an LTE network, a 5G/NR network, an IoT network or a 6G network). Referring to FIG. 16, the network node may transmit the instructions to the UE reader. Then, the UE reader may transmit the instructions to the A-IoT device via signals. The A-IoT device may generate a waveform or adjust its power levels according to the instructions. Then, the UE reader may report the actions or operations associated with the A-IoT device to the network node. In addition, the network node may also send a specific signal to the A-IoT device via the UE reader to trigger the A-IoT device to send its status information to the UE reader. Then, the UE reader may transmit the status information of the A-IoT device to the network node. The A-IoT device may only communicate with the UE reader without directly communicating with the network node.

The A-IoT device may operate according to received signals from the UE reader. The UE reader may communicate with the network node through the Uu interface and transmit the instructions from the network node to the A-IoT device. For example, the A-IoT device may receive a signal from the UE reader where the signal may indicate a request for transmitting data. In another example, the A-IoT device may receive an instruction from the UE reader to adjust its power levels.

When the A-IoT device receives the signals from the UE reader, the A-IoT device may generates its own waveform using an equation indicated in the signals. In an example, the waveform generation may involve the parameters such as 12 subcarriers, 7 common resource blocks, and a PRACH sequence length of 839. In another example, for a different configuration, the waveform generation may involve 24 subcarriers, 14 common resource blocks, and a PRACH sequence length of 1393. When the waveform is generated, the A-IoT device may transmit the waveform to the UE reader.

The A-IoT device may adjust its transmission power according to the A-IoT-power IE from the UE reader. For example, if the UE reader receives an instruction from the network node to use two layers for the PUSCH, the UE reader may determine the A-IoT-power IE according to the instruction and transmit the A-IoT-power IE to the A-IoT device. The A-IoT device may boost its transmission power by 3 dB according to the A-IoT-power IE. Accordingly, if the UE reader receives a command for power reduction from the network node, the A-IoT device may decrease its transmission power by 2 dB.

The actions of the A-IoT device may be triggered by certain conditions, such as receiving a specific signal from the UE reader. For example, the A-IoT device may be triggered to send its status information when the A-IoT device receives a specific signal from the UE reader. In another example, the A-IoT device may adjust its power levels when the A-IoT device receives a power control command from the UE reader.

The improvement for optimizing the A-IoT data handling process may be required, specifically for the error detection for the small data, for the resource allocation for the medium data, and for the decision-making for the large data segmentation.

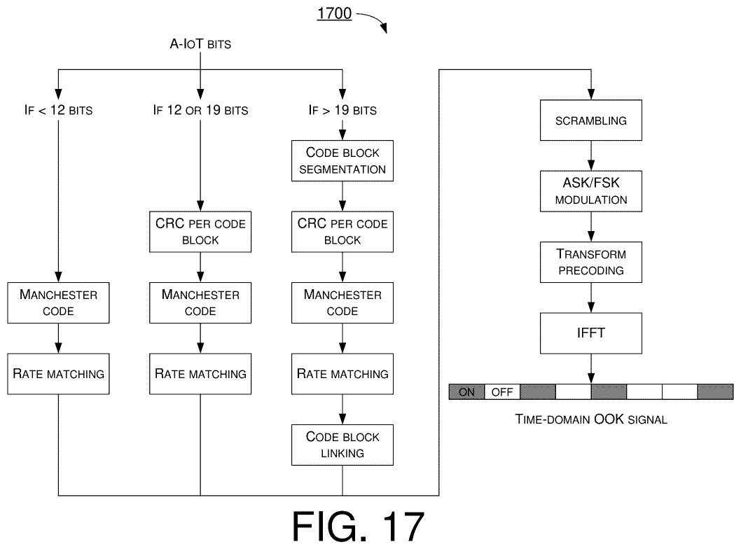

FIG. 17 illustrates an example scenario 1700 for a data handling process based on the DFT-s-OFDM in accordance with implementations of the present disclosure. Scenario 1700 involves a UE (or UE reader), an A-IoT device and a network node (e.g., a (macro/micro) base station) which may be a part of a wireless network (e.g., an LTE network, a 5G/NR network, an IoT network or a 6G network). Referring to FIG. 17, the application of the code block segmentation, the CRC bits, and the rate matching for different data sizes may be discussed. FIG. 17 may also illustrate the methods of scrambling and sequence generation.

For small-sized data (e.g., the data size is less than 12 bits), the A-IoT device may not perform the code block segmentation or the addition of CRC bits. The A-IoT device may decode the received data according to the redundancy generated through the specific block coding method (e.g., Manchester code) used by the UE reader or network node. In addition, the A-IoT device may use the rate matching to ensure the bits fit precisely within the allocated resources. If the number of bits needs to be increased, the A-IoT device may use the repetition to meet the required bit count.

For the medium-sized data (e.g., the data size is in the range from 12 bits to 19 bits), the A-IoT device may perform the addition of CRC bits for the error detection at the network node, but not perform the code block segmentation. The A-IoT device may use a specific method (e.g., Manchester code) for channel coding to protect the data (or information) transmission. In addition, the A-IoT device may apply the rate matching to ensure the bits fit accurately within the allocated resources.

For the large-sized data (e.g., the data size is larger than 19 bits), the A-IoT device may perform the code block segmentation according to the number of bits to be transmitted. The code block segmentation may generate up to two code blocks. The CRC bits may be added for error detection, and a specific method (e.g., Manchester code) may be used for channel coding. The rate matching may be performed to ensure the bits fit accurately within the allocated resources. In addition, the A-IoT device may decipher the segmented blocks and reassemble them for further processing.

In order to randomize the transmitted bit stream and minimize interference with neighboring devices, the A-IoT device may perform the scrambling operation. The scrambling sequence generator may be initialized according to a configuration to generate the scrambling sequence. The configuration may comprise the device-specific identifier and the value of a specific configuration parameter. The A-IoT device may descramble the received bitstream using the same scrambling sequence.

The rate matching may be used to process each channel coded segment separately. This rate matching may comprise two stages. One stage may be the bit selection, and the other stage may be the bit interleaving. The bit selection may reduce the number of channel coded bits to match the capacity of the allocated air-interface resources. The bit Interleaving may be used to rearrange the bit sequence. Then, the A-IoT device may perform the inverse operations (or processes) of the rate matching to recover the original bit sequence.

The UE (or UE reader) may support to transmit the A-IoT signal (or OOK signal) through either CP-OFDM waveforms or DFT-s-OFDM waveforms. The UE may select the CP-OFDM and DFT-s-OFDM for transmitting A-IoT signals according to the network conditions (e.g., the data type) and UE capabilities. The UE may select the DFT-s-OFDM for the single-stream transmissions when the UE does not support MIMO. The network node may indicate the UE to use which waveform through the control signaling.

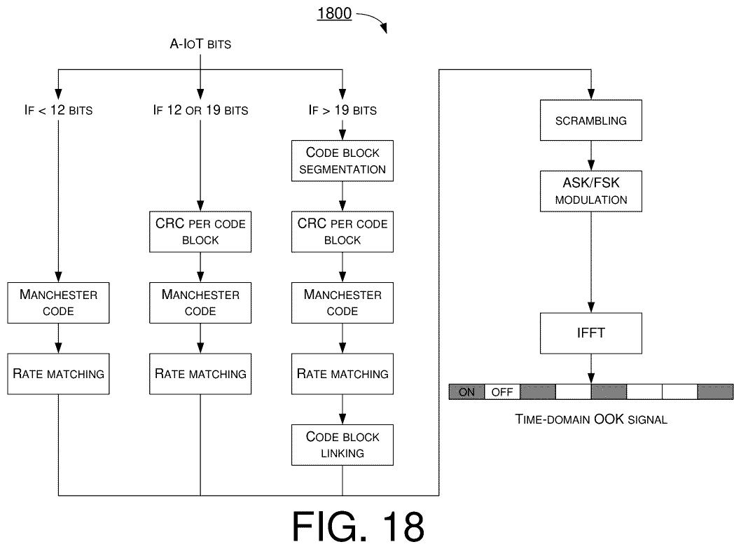

FIG. 18 illustrates an example scenario 1800 for a data processing procedure based on the CP-OFDM in accordance with implementations of the present disclosure. Scenario 1800 involves a UE (or UE reader), an A-IoT device and a network node (e.g., a (macro/micro) base station) which may be a part of a wireless network (e.g., an LTE network, a 5G/NR network, an IoT network or a 6G network). Referring to FIG. 18, the process of the code block segmentation, the CRC bits, and the rate matching for different data sizes may be discussed. FIG. 18 may also illustrate the methods of scrambling and sequence generation.

For small-sized data (e.g., the data size is less than 12 bits), the A-IoT device may not perform the code block segmentation or addition of CRC bits. The A-IoT device may decode the received data according to the redundancy generated through the specific block coding method (e.g., the Manchester code) used by the UE reader or the network node. In addition, the A-IoT device may perform the rate matching to fit the bits precisely within the allocated resources. If the number of bits needs to be increased, the A-IoT device may use the repetition to meet the required bit count.

For the medium-sized data (e.g., the data size is in the range from 12 bits to 19 bits), the A-IoT device may perform the addition of CRC bits for error detection at the network node, but still not perform the code block segmentation. The A-IoT device may use a specific method (e.g., the Manchester code) for channel coding to decipher during data (or information) transmission. In addition, the A-IoT device may perform the rate matching to fit the bits accurately within the allocated resources.

For the large-sized data (e.g., the data size is larger than 19 bits), the A-IoT device may perform the code block segmentation according to the number of bits to be transmitted. The code block segmentation may generate up to two code blocks. The CRC bits may be added for the error detection, and a specific method (e.g., the Manchester code) may be used for channel coding. In addition, the A-IoT device may perform the rate matching to fit the bits accurately within the allocated resources. In addition, the A-IoT device may decipher the segmented blocks and reassemble them for further processing.

In order to decipher the transmitted bit stream and reduce the interference with neighboring devices, the A-IoT device may perform the descrambling. The scrambling sequence generator may be initialized according to a configuration to generate the scrambling sequence. The configuration may comprise the device-specific identifier and the value of a specific configuration parameter. The A-IoT device may descramble the received bitstream using the same scrambling sequence.

The rate matching function supported by the UE reader or the network node may be used to process each channel coded segment independently. This matching may have two stages. One stage may be the bit selection and the other stage may be the bit Interleaving. The bit selection may reduce the number of channel coded bits to match the capacity of the allocated air-interface resources. The bit Interleaving may be used to rearrange the bit sequence. Then, the A-IoT device may perform the inverse operations (or processes) of the rate matching to recover the original bit sequence.

The signaling between the A-IoT device and the UE reader may ensure that the data is transmitted accurately and efficiently. The UE reader may transmit the signals indicating the size of the data, whether CRC bits are added, and whether code block segmentation is used. The A-IoT device may confirm the signals, decode the received data, check for errors, and transmit an acknowledgment signal to the UE reader.

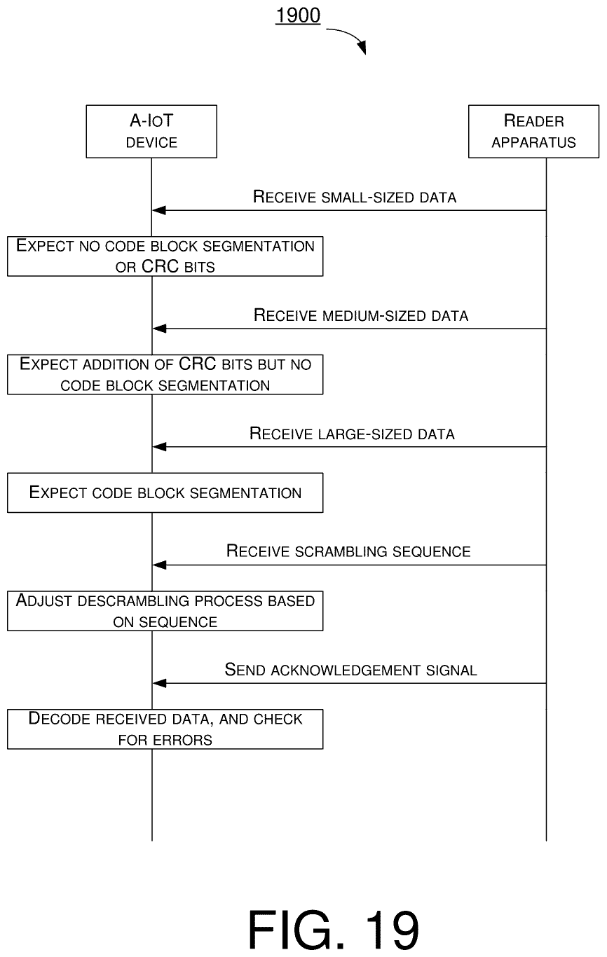

FIG. 19 illustrates an example scenario 1900 for a data transmission process based on the DFT-s-OFDM or CP-OFDM in accordance with implementations of the present disclosure. Scenario 1900 involves an A-IoT device and a reader apparatus (e.g., a UE (or UE reader), or a network node (e.g., a (macro/micro) base station) which may be a part of a wireless network (e.g., an LTE network, a 5G/NR network, an IoT network or a 6G network)). Referring to FIG. 19, the A-IoT device may receive different sizes of data from the reader apparatus (e.g., a UE reader or a network node). The A-IoT device may perform different operations according to the data size. The A-IoT device also receives a scrambling sequence from the reader apparatus to adjust its descrambling process accordingly. After decoding the received data and checking for errors, the A-IoT device may transmit or send an acknowledgment signal to the reader apparatus.

The operations or behaviors of the A-IoT device may be varied according to the configurations or signaling received from the reader apparatus (e.g., a UE reader or a network node). The configurations or signals may affect how the A-IoT device processing the received data with small-sized, medium-sized, or large-sized.

When the A-IoT device receives the small-sized data, the A-IoT device may not perform (or may expect no) code block segmentation or addition of CRC bits. However, if the reader apparatus (e.g., a UE reader or a network node) transmits a signal or configuration indicating the use of code block segmentation or CRC bits, the A-IoT device may adjust its decoding process accordingly. For example, the A-IoT device may use a specific decoding method to handle the segmented blocks or use CRC bits for error detection.

When the A-IoT device receives the medium-sized data, the A-IoT device may perform (or expect) the addition of CRC bits for error detection, but not perform (or expect no) code block segmentation. If the reader apparatus (e.g., a UE reader or a network node) transmits a signal indicating the use of code block segmentation, the A-IoT device may adjust its decoding process according to the signal to handle the segmented data. Similarly, if the reader apparatus (e.g., a UE reader or a network node) transmits a configuration indicating a different method for error detection, the A-IoT device may also adjust its decoding process according to the different method.

When the A-IoT device receives the large-sized data, the A-IoT device may perform (or expect) the code block segmentation. If the reader apparatus (e.g., a UE reader or a network node) transmits a configuration specifying a limit on the size of each code block, the A-IoT device may adjust its decoding process according to the configuration to handle the smaller blocks. Similarly, if the reader apparatus (e.g., a UE reader or a network node) transmits a signal indicating the use of a specific channel coding method, the A-IoT device may adjust its decoding process according to the specific channel coding method to decipher the data according to the specific channel coding method.

The scrambling sequence generator of the A-IoT device may be initialized according to a configuration (or a formula) that may comprise the device-specific identifier and the value of a specific configuration parameter. However, if the reader apparatus (e.g., a UE reader or a network node) transmits a configuration specifying a different configuration (or formula) or parameters for the scrambling sequence, the A-IoT device may adjust its descrambling process accordingly.

### Illustrative Implementations

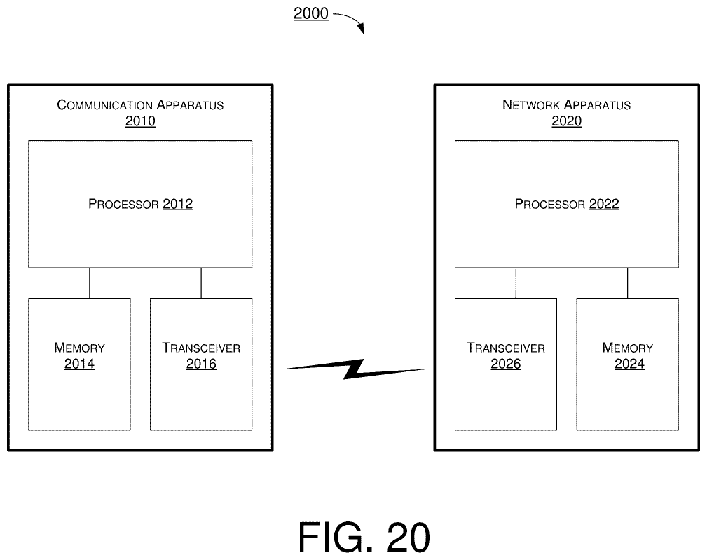

FIG. 20 illustrates an example communication system 2000 having at least an example communication apparatus 2010 and an example network apparatus 2020 in accordance with an implementation of the present disclosure. Each of communication apparatus 2010 and network apparatus 2020 may perform various functions to implement schemes, techniques, processes and methods described herein pertaining to OOK signal generation, including the various schemes described above with respect to various proposed designs, concepts, schemes and methods described above and with respect to user equipment and network apparatus in mobile communications, including scenarios/schemes described above as well as process 2100 and process 2200 described below.

Communication apparatus 2010 may be a part of an electronic apparatus, which may be a UE such as a portable or mobile apparatus, a wearable apparatus, a wireless communication apparatus or a computing apparatus. For instance, communication apparatus 2010 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 2010 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 2010 may be implemented in a smart thermostat, a smart fridge, a smart door lock, a wireless speaker or a home control center. Alternatively, communication apparatus 2010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 2010 may include at least some of those components shown in FIG. 20 such as a processor 2012, for example. Communication apparatus 2010 may further include one or more other components not pertinent to the proposed schemes of the present disclosure (e.g., internal power supply, display device and/or user interface device), and, thus, such component(s) of communication apparatus 2010 are neither shown in FIG. 20 nor described below in the interest of simplicity and brevity.

Network apparatus 2020 may be a part of an electronic apparatus, which may be a network node such as a satellite, a BS, a small cell, a router or a gateway of an IoT network. For instance, network apparatus 2020 may be implemented in a satellite or an eNB/gNB/TRP in a 4G/5G/B5G/6G, NR, IoT, NB-IoT or IIoT network. Alternatively, network apparatus 2020 may be implemented in the form of one or more IC chips such as, for example and without limitation, one or more single-core processors, one or more multi-core processors, or one or more RISC or CISC processors. Network apparatus 2020 may include at least some of those components shown in FIG. 20 such as a processor 2022, for example. Network apparatus 2020 may further include one or more other components not pertinent to the proposed scheme of the present disclosure (e.g., internal power supply, display device and/or user interface device), and, thus, such component(s) of network apparatus 2020 are neither shown in FIG. 20 nor described below in the interest of simplicity and brevity.

In one aspect, each of processor 2012 and processor 2022 may be implemented in the form of one or more single-core processors, one or more multi-core processors, or one or more CISC processors. That is, even though a singular term “a processor” is used herein to refer to processor 2012 and processor 2022, each of processor 2012 and processor 2022 may include multiple processors in some implementations and a single processor in other implementations in accordance with the present disclosure. In another aspect, each of processor 2012 and processor 2022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 2012 and processor 2022 is a special-purpose machine specifically designed, arranged and configured to perform specific tasks, including OOK signal generation, in a device (e.g., as represented by communication apparatus 2010) and a network node (e.g., as represented by network apparatus 2020) in accordance with various implementations of the present disclosure.

In some implementations, communication apparatus 2010 may also include a transceiver 2016 coupled to processor 2012 and capable of wirelessly transmitting and receiving data. In some implementations, transceiver 2016 may be capable of wirelessly communicating with different types of UEs and/or wireless networks of different radio access technologies (RATs). In some implementations, transceiver 2016 may be equipped with a plurality of antenna ports (not shown) such as, for example, four antenna ports. That is, transceiver 2016 may be equipped with multiple transmit antennas and multiple receive antennas for multiple-input multiple-output (MIMO) wireless communications. In some implementations, network apparatus 2020 may also include a transceiver 2026 coupled to processor 2022. Transceiver 2026 may include a transceiver capable of wirelessly transmitting and receiving data. In some implementations, transceiver 2026 may be capable of wirelessly communicating with different types of UEs of different RATs. In some implementations, transceiver 2026 may be equipped with a plurality of antenna ports (not shown) such as, for example, four antenna ports. That is, transceiver 2026 may be equipped with multiple transmit antennas and multiple receive antennas for MIMO wireless communications.

In some implementations, communication apparatus 2010 may further include a memory 2014 coupled to processor 2012 and capable of being accessed by processor 2012 and storing data therein. In some implementations, network apparatus 2020 may further include a memory 2024 coupled to processor 2022 and capable of being accessed by processor 2022 and storing data therein. Each of memory 2014 and memory 2024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 2014 and memory 2024 may include a type of read-only memory (ROM) such as mask ROM, programmable ROM (PROM), erasable programmable ROM (EPROM) and/or electrically erasable programmable ROM (EEPROM). Alternatively, or additionally, each of memory 2014 and memory 2024 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 2010 and network apparatus 2020 may be a communication entity capable of communicating with each other using various proposed schemes in accordance with the present disclosure. For illustrative purposes and without limitation, descriptions of capabilities of communication apparatus 2010, as a UE, and network apparatus 2020, as a network node (e.g., TRP), are provided below with process 2100 and process 2200.

### Illustrative Processes

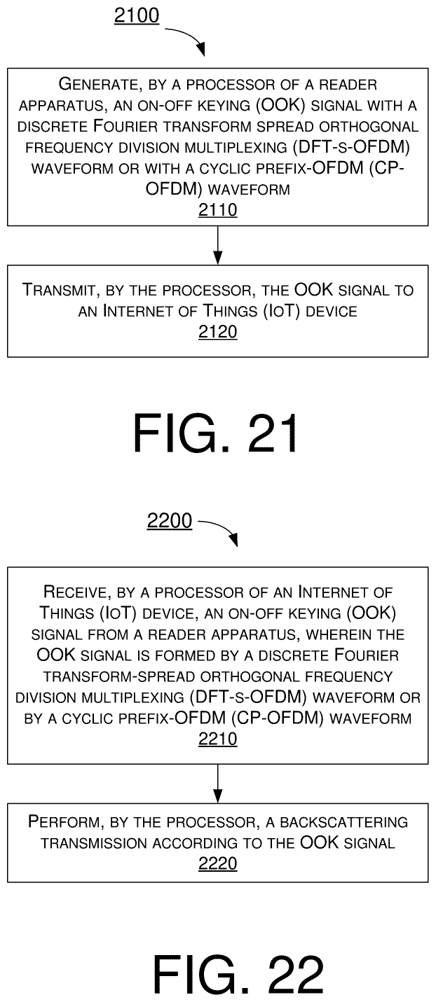

FIG. 21 illustrates an example process 2100 in accordance with an implementation of the present disclosure. Process 2100 may be an example implementation of above scenarios/schemes, whether partially or completely, with respect to OOK signal generation with the present disclosure. Process 2100 may represent an aspect of implementation of features of communication apparatus 2010 and/or network apparatus 2020. Process 2100 may include one or more operations, actions, or functions as illustrated by one or more of blocks 2110, and 2120. Although illustrated as discrete blocks, various blocks of process 2100 may be divided into additional blocks, combined into fewer blocks, or eliminated, depending on the desired implementation. Moreover, the blocks of process 2100 may be executed in the order shown in FIG. 21 or, alternatively, in a different order. Process 2100 may be implemented by communication apparatus 2010 or any suitable reader apparatus. Solely for illustrative purposes and without limitation, process 2100 is described below in the context of communication apparatus 2010. Process 2100 may begin at block 2110.

At 2110, process 2100 may involve processor 2012 of communication apparatus 2010 generating an OOK signal with a DFT-s-OFDM waveform or with a CP-OFDM waveform. Process 2100 may proceed from 2110 to 2120.

At 2120, process 2100 may involve processor 2012 transmitting, via transceiver 2016, the OOK signal to an IoT device.

In some implementations, process 2100 may involve processor 2012 performing a DFT calculation. Process 2100 may involve processor 2012 performing an IDFT calculation. Process 2100 may involve processor 2012 adding a CP to the OOK signal.

In some implementations, process 2100 may involve processor 2012 performing a transform precoding for the OOK signal.

In some implementations, process 2100 may involve processor 2012 receiving, via transceiver 2016, a power adjustment indication from a network node. Process 2100 may involve processor 2012 transmitting, via transceiver 2016, a power adjustment signal to the IoT device.

In some implementations, process 2100 may involve processor 2012 determining an equation according to a resource configuration for the OOK signal from a network node. Process 2100 may involve processor 2012 generating the DFT-s-OFDM waveform or the CP-OFDM waveform according to the equation.

In some implementations, process 2100 may involve processor 2012 determining an IoT-power IE. Process 2100 may involve processor 2012 transmitting, via transceiver 2016, the IoT-power IE to the IoT device.

In some implementations, process 2100 may involve processor 2012 determining whether to perform at least one of a CRC and code block segmentation to generate the OOK signal.

FIG. 22 illustrates an example process 2200 in accordance with another implementation of the present disclosure. Process 2200 may be an example implementation of above scenarios/schemes, whether partially or completely, with respect to OOK signal generation with the present disclosure. Process 2200 may represent an aspect of implementation of features of network apparatus 2020 and/or communication apparatus 2020. Process 2200 may include one or more operations, actions, or functions as illustrated by one or more of blocks 2210 and 2220. Although illustrated as discrete blocks, various blocks of process 2200 may be divided into additional blocks, combined into fewer blocks, or eliminated, depending on the desired implementation. Moreover, the blocks of process 2200 may be executed in the order shown in FIG. 22 or, alternatively, in a different order. Process 2200 may be implemented by communication apparatus 2010 or any suitable IoT device. Solely for illustrative purposes and without limitation, process 2200 is described below in the context of communication apparatus 2010. Process 2200 may begin at block 2210.

At 2210, process 2200 may involve processor 2012 of communication apparatus 2010 receiving, via transceiver 2016, an OOK signal from a reader apparatus, wherein the OOK signal is formed by a DFT-s-OFDM waveform or by a CP-OFDM waveform. Process 2200 may proceed from 2210 to 2220.

At 2220, process 2200 may involve processor 2012 performing a backscattering transmission according to the OOK signal.

In some implementations, the OOK signal is generated by using a transform precoding.

In some implementations, process 2200 may involve processor 2012 receiving, via transceiver 2016, a power adjustment indication from a network node. Process 2200 may involve processor 2012 transmitting, via transceiver 2016, a power adjustment signal to the IoT device.

In some implementations, process 2200 may involve processor 2012 determining an equation according to a resource configuration for the OOK signal from a network node. Process 2200 may involve processor 2012 generating the DFT-s-OFDM waveform or the CP-OFDM waveform according to the equation.

In some implementations, process 2200 may involve processor 2012 determining an IoT-power IE. Process 2200 may involve processor 2012 transmitting, via transceiver 2016, the IoT-power IE to the IoT device.

In some implementations, process 2200 may involve processor 2012 determining whether to perform at least one of a CRC and code block segmentation to generate the OOK signal.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of a reader apparatus, an on-off keying (OOK) signal with a discrete Fourier transform spread orthogonal frequency division multiplexing (DFT-s-OFDM) waveform or with a cyclic prefix-OFDM (CP-OFDM) waveform; and
transmitting, by the processor, the OOK signal to an Internet of Things (IoT) device.

2. The method of claim 1, wherein the generating of the OOK signal comprises:
performing, by the processor, a DFT calculation;
performing, by the processor, an inverse DFT (IDFT) calculation; and
adding a CP to the OOK signal.

3. The method of claim 1, further comprising:
performing, by the processor, a transform precoding for the OOK signal.

4. The method of claim 1, further comprising:
receiving, by the processor, a power adjustment indication from a network node; and
transmitting, by the processor, a power adjustment signal to the IoT device.

5. The method of claim 1, further comprising:
determining, by the processor, an equation according to a resource configuration for the OOK signal from a network node; and
generating, by the processor, the DFT-s-OFDM waveform or the CP-OFDM waveform according to the equation.

6. The method of claim 1, further comprising:
determining, by the processor, an IoT-power information element (IE); and
transmitting, by the processor, the IoT-power IE to the IoT device.

7. The method of claim 1, further comprising:
determining, by the processor, whether to perform at least one of a cyclic redundancy check (CRC) and code block segmentation to generate the OOK signal.

8. A method, comprising:
receiving, by a processor of an Internet of Things (IoT) device, an on-off keying (OOK) signal from a reader apparatus, wherein the OOK signal is formed by a discrete Fourier transform-spread orthogonal frequency division multiplexing (DFT-s-OFDM) waveform or by a cyclic prefix-OFDM (CP-OFDM) waveform; and
performing, by the processor, a backscattering transmission according to the OOK signal.

9. The method of claim 8, wherein the OOK signal is generated by using a transform precoding.

10. The method of claim 8, further comprising:
receiving, by the processor, a power adjustment signal from the reader apparatus; and
performing, by the processor, a power management according to the power adjustment signal.

11. The method of claim 8, further comprising:
determining, by the processor, an equation according to a resource configuration for the OOK signal; and
generating, by the processor, the backscattering transmission based on the equation.

12. The method of claim 8, further comprising:
receiving, by the processor, an IoT-power information element (IE) from the reader apparatus; and
performing, by the processor, a power management according to the IoT-power IE.

13. The method of claim 8, further comprising:
determining, by the processor, whether at least one of a cyclic redundancy check (CRC) and code block segmentation is performed on the OOK signal.

14. An apparatus, comprising:
a transceiver which, during operation, wirelessly communicates with at least one network node of a wireless network; and
a processor communicatively coupled to the transceiver such that, during operation, the processor performs operations comprising:
generating an on-off keying (OOK) signal with a discrete Fourier transform spread orthogonal frequency division multiplexing (DFT-s-OFDM) waveform or with a cyclic prefix-OFDM (CP-OFDM) waveform; and
transmitting, via the transceiver, the OOK signal to an Internet of Things (IoT) device.

15. The apparatus of claim 14, wherein, in generating the OOK signal, the processor performs a DFT calculation and an inverse DFT (IDFT) calculation, and adds a CP to the OOK signal.

16. The apparatus of claim 15, wherein the processor is further configured to perform operations comprising:
performing a transform precoding for the OOK signal.

17. The apparatus of claim 14, wherein the processor is further configured to perform operations comprising:
receiving, via the transceiver, a power adjustment indication from the network node; and
transmitting, via the transceiver, a power adjustment signal to the IoT device.

18. The apparatus of claim 14, wherein the processor is further configured to perform operations comprising:
determining an equation according to a resource configuration for the OOK signal from the network node; and
generating the DFT-s-OFDM waveform or the CP-OFDM waveform according to the equation.

19. The apparatus of claim 14, wherein the processor is further configured to perform operations comprising:
determining an IoT-power information element (IE); and
transmitting, via the transceiver, the IoT-power IE to the IoT device.

20. The apparatus of claim 14, wherein the processor is further configured to perform operations comprising:
determining, by the processor, whether to perform at least one of a cyclic redundancy check (CRC) and code block segmentation to generate the OOK signal.
